(19) United States
(12) Patent Application Publication
(10) Pub. No.: US 2021/0247032 A1
(43) Pub. Date: Aug. 12, 2021

(54) LIGHT SOURCE MODULE AND ELECTRONIC DEVICE USING SAME

(71) Applicant: Primax Electronics Ltd., Taipei (TW)

(72) Inventors: Hsiang-Mei Chiang, Taipei (TW); Wei-Chiang Huang, Taipei (TW); Ming-Hui Yeh, Taipei (TW)

(21) Appl. No.: 16/833,824

(22) Filed: Mar. 30, 2020

(30) Foreign Application Priority Data
Feb. 7, 2020 (TW) 109103922

(51) Int. Cl. F21K 9/62; F21V 33/00; H04R 1/02

(52) U.S. Cl. CPC F21K 9/62; F21Y 2115/10; H04R 1/028; F21V 33/0056

(57) ABSTRACT

A light source module includes a supporting substrate, plural light-emitting unit and a light mixing structure. The light mixing structure is disposed on the supporting substrate. The light mixing structure includes plural crooked light mixing channels. After the light beams emitted by the light-emitting unit are introduced into the corresponding light mixing channel, the light beams are mixed together in the corresponding light mixing channel, and the mixed light beams are outputted from the corresponding light mixing channel. Moreover, an electronic device with the light source module is provided.

### FIELD OF THE INVENTION

The present invention relates to an optical device, and more particularly to a light source module and an electronic device with the light source module.

### BACKGROUND OF THE INVENTION

With the development of electronic industries and the advance of industrial technologies, various electronic products are designed toward small size, slimness, light weightiness and easy portability. Consequently, these electronic products can be applied to mobile business, entertainment or leisure purposes whenever or wherever the users are. Recently, people pay much attention to the integrations and applications of mechanical, optical and electrical technologies. Consequently, a variety of light source modules are gradually and extensively applied to various electronic products. For example, a light source module is applied to an audio device for playing music (e.g., a loudspeaker). Consequently, the audio device provides a luminous efficacy.

FIG. 1 schematically illustrates the architecture of a conventional light source module. As shown in FIG. 1, the light source module 1 comprises a light mixing structure 11 and plural light emitting diodes 12. The light mixing structure 11 has a tubular shape. Moreover, the light mixing structure 11 comprises an inlet 111 and an outlet 112. The plural light emitting diodes 12 are arranged near the inlet 111 of the light mixing structure 11. The plural light emitting diodes 12 emit plural light beams L1. After the plural light beams L1 are introduced into the light mixing structure 11 through the inlet 111 of the light mixing structure 11, the plural light beams L1 are refracted and scattered many times. Consequently, the plural light beams L1 are mixed together. Then, the mixed light beams L1 are outputted from the outlet 112 of the light mixing structure 11. Consequently, the light source module 1 can provide light beams with satisfied color uniformity.

Generally, the color uniformity of the light beams provided by the light source module 1 is in direct proportion to the length of the light mixing structure 11. As the length of the light mixing structure 11 is increased, the color uniformity of the light beams provided by the light source module 1 is enhanced. However, if the light mixing structure 11 is too long, the light energy loss increases and the volume of the light source module 1 is unable to be effectively reduced. Moreover, in case that the mixing structure 11 is applied to an electronic device, the long light mixing structure 11 is detrimental to the development of the electronic device toward small size, slimness and light weightiness. As the length of the light mixing structure 11 is decreased, the volume of the light source module 1 is reduced but the light-mixing uniformity is impaired.

In other words, the conventional light source module and the electronic device with the light source module need to be further improved.

### SUMMARY OF THE INVENTION

An object of the present invention provides a light source module with a light mixing structure. The light mixing structure includes plural light mixing channels. Each light mixing channel has a crooked shape. The light beams from plural light-emitting units are introduced into the light mixing channels and mixed together in the light mixing channels. Consequently, even if the light source module is slim, the light source module can provide uniform light-mixing efficacy.

Another object of the present invention provides an electronic device with the light source module. Consequently, even if the light source module is slim, the light source module can provide the luminous efficacy. When the light source module is applied to the electronic device, the electronic device can be developed toward small size, slimness and light weightiness.

In accordance with an aspect of the present invention, a light source module is provided. The light source module includes a supporting substrate, plural light-emitting units and a light mixing structure. The plural light-emitting units are electrically connected with the supporting substrate. The plural light-emitting units emit light beams. The light mixing structure is disposed on the supporting substrate. The light mixing structure includes plural light mixing channels, and the light mixing channels are aligned with the corresponding light-emitting units, respectively. Moreover, at least one of the plural light mixing channels has a crooked shape, and each light mixing channel has a channel inlet and a channel outlet. Each light-emitting unit is located at the channel inlet of the corresponding light mixing channel. After the light beams emitted by each light-emitting unit are introduced into the corresponding light mixing channel through the channel inlet, the light beams are mixed together in the corresponding light mixing channel, and the mixed light beams are outputted from the channel outlet of the corresponding light mixing channel.

In an embodiment, each light-emitting unit includes a red light emitting diode chip, a green light emitting diode chip and a blue light emitting diode chip. The red light emitting diode chip emits a red light beam. The green light emitting diode chip emits a green light beam. The blue light emitting diode chip emits a blue light beam.

In an embodiment, the red light emitting diode chip, the green light emitting diode chip and the blue light emitting diode chip are packaged as a polychromatic light emitting diode chip.

In an embodiment, each light-emitting unit includes at least one micro light emitting diode chip.

In an embodiment, the light mixing channel with the crooked shape has a helical path.

In an embodiment, an inner surface of each light mixing channel has an irregular surface or a discontinuity surface, and the light beams are reflected or diffused by the inner surface of the light mixing channel.

In an embodiment, the supporting substrate is a flexible printed circuit board (FPC), a printed circuit board (PCB) or a resin board (PET).

In an embodiment, the light mixing structure has a ring-shaped profile.

In an embodiment, the light source module is installed in a sound playback device.

In accordance with another aspect of the present invention, an electronic device is provided. The electronic device includes a casing, a circuit module and a light source module. The circuit module is installed in the casing. The circuit module provides an electronic function. The light source module is installed on the casing. The light source module includes a supporting substrate, a light-emitting unit and a light mixing structure. The light-emitting unit is electrically connected with the supporting substrate. The light-emitting unit emits light beams. The light mixing structure is disposed on the supporting substrate. The light mixing structure includes a light mixing channel. The light mixing channel is aligned with the light-emitting unit. The light mixing channel has a crooked shape. The light mixing channel has a channel inlet and a channel outlet. The light-emitting unit is located at the channel inlet of the light mixing channel. After the light beams emitted by the light-emitting unit are introduced into the light mixing channel through the channel inlet, the light beams are mixed together in the light mixing channel, and the mixed light beams are outputted from the channel outlet of the light mixing channel.

In an embodiment, the light-emitting unit includes a red light emitting diode chip, a green light emitting diode chip and a blue light emitting diode chip. The red light emitting diode chip emits a red light beam. The green light emitting diode chip emits a green light beam. The blue light emitting diode chip emits a blue light beam.

In an embodiment, the red light emitting diode chip, the green light emitting diode chip and the blue light emitting diode chip are packaged as a polychromatic light emitting diode chip.

In an embodiment, the light-emitting unit includes at least one micro light emitting diode chip.

In an embodiment, the light mixing channel has a helical path.

In an embodiment, an inner surface of the light mixing channel has an irregular surface or a discontinuity surface, and the light beams are reflected or diffused by the inner surface of the light mixing channel.

In an embodiment, the supporting substrate is a flexible printed circuit board (FPC), a printed circuit board (PCB) or a resin board (PET).

In an embodiment, the light mixing structure has a ring-shaped profile.

In an embodiment, the electronic device is a sound playback device.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the architecture of a conventional light source module;

FIG. 2 is a schematic perspective view illustrating a structure of an electronic device according to an embodiment of the present invention; and

FIG. 3 is a schematic cross-sectional view illustrating a portion of the electronic device as shown in FIG. 2.

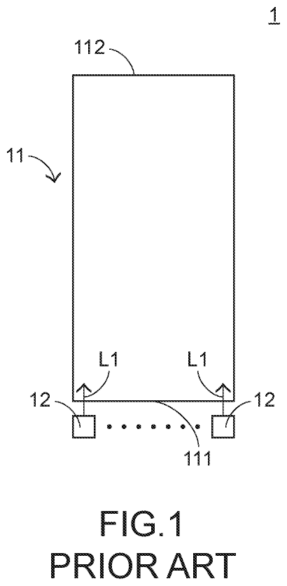

### DETAILED DESCRIPTION OF THE PREFERRED EMBODIMENT

The embodiments of present invention will be described more specifically with reference to the following drawings. Generally, in the drawings and specifications, identical or similar components are designated by identical numeral references. For well understanding the present invention, the elements shown in the drawings are not in scale with the elements of the practical product. In the following embodiments and drawings, the elements irrelevant to the concepts of the present invention or the elements well known to those skilled in the art are omitted. It is noted that numerous modifications and alterations may be made while retaining the teachings of the invention.

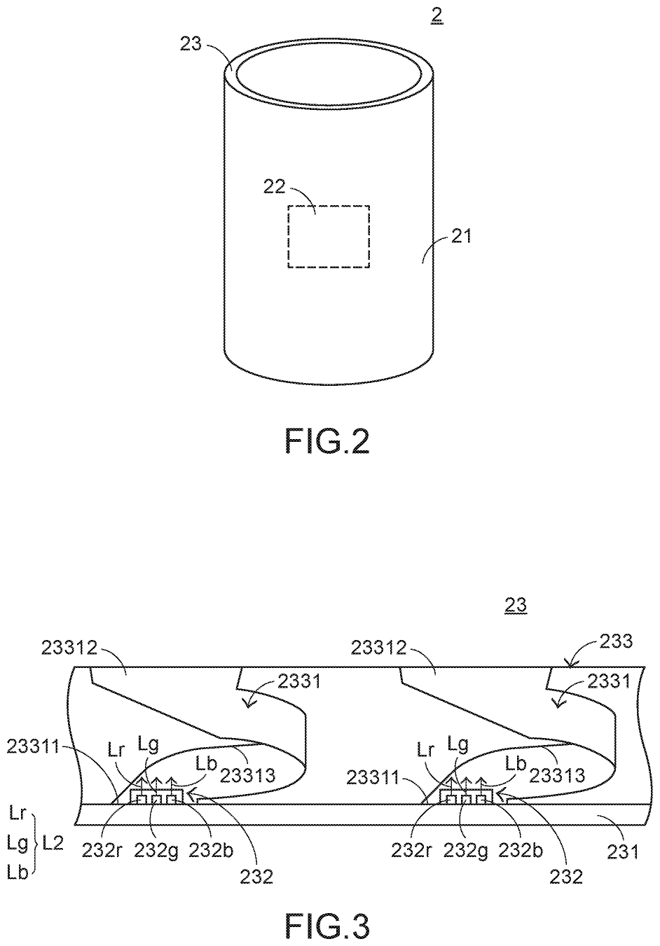

Please refer to FIGS. 2 and 3. FIG. 2 is a schematic perspective view illustrating a structure of an electronic device according to an embodiment of the present invention. FIG. 3 is a schematic cross-sectional view illustrating a portion of the electronic device as shown in FIG. 2. The electronic device 2 comprises a casing 21, a circuit module 22 and a light source module 23. The circuit module 22 is installed within the casing 21 to provide an electronic function. The light source module 23 is disposed on the casing 21 and electrically connected with the circuit module 22. Due to the arrangement of the light source module 23, the electronic device 2 provides the luminous efficacy. In an embodiment, the electronic device 2 is a sound playback device such as a loudspeaker or an audio device. The circuit module 22 is used for providing an electronic function associated with the sound playback function.

The light source module 23 comprises a supporting substrate 231, plural light-emitting units 232 and a light mixing structure 233. The plural light-emitting units 232 are disposed on the supporting substrate 231 and electrically connected with the supporting substrate 231. The light mixing structure 233 is disposed on the supporting substrate 231. Moreover, the light mixing structure 233 comprises plural light mixing channels 2331. Each of the light mixing channels 2331 has a crooked shape. Moreover, the light mixing channel 2331 has a channel inlet 23311 and a channel outlet 23312. Each of the light mixing channels 2331 is aligned with a corresponding light-emitting unit 232. That is, each light-emitting unit 232 is located at the channel inlet 23311 of the corresponding light mixing channel 2331. When the light-emitting unit 232 receives electric power through the supporting substrate 231, the light-emitting unit 232 emits light beams L2. The light beams L2 are introduced into the light mixing channel 2331 through the channel inlet 23311. The light beams L2 are mixed together in the light mixing channel 2331. The mixed light beams are outputted from the channel outlet 23312.

In an embodiment, the casing 21 of the electronic device 2 has a cylindrical shape. The supporting substrate 231 is disposed on the casing 21. Moreover, the supporting substrate 231 has a circular disc shape. The light mixing structure 233 is disposed on the supporting substrate 231 has a ring-shaped profile matching the casing 21 and the supporting substrate 231. The supporting substrate 231 is a flexible printed circuit board (FPC), a printed circuit board (PCB) or a resin board (e.g., a PET board). In an embodiment, the supporting substrate 231 and the circuit module 22 are two individual components through an electric connection means (e.g., a wire). Alternatively, the supporting substrate 231 and the circuit module 22 are integrated as a one-piece component.

In an embodiment, each light-emitting unit 232 comprises a red light emitting diode chip 232r, a green light emitting diode chip 232g and a blue light emitting diode chip 232b. The red light emitting diode chip 232r emits a red light beam Lr. The green light emitting diode chip 232g emits a green light beam Lg. The blue light emitting diode chip 232b emits a blue light beam Lb. The red light beam Lr, the green light beam Lg and the blue light beam Lb are mixed together in the light mixing structure 233. Each of the red light emitting diode chip 232r, the green light emitting diode chip 232g and the blue light emitting diode chip 232b is an ordinary LED chip or a micro LED chip. Moreover, the red light emitting diode chip 232r, the green light emitting diode chip 232g and the blue light emitting diode chip 232b are packaged as a polychromatic LED chip.

As mentioned above, each light mixing channel 2331 of the light mixing structure 233 has a crooked shape. Since the optical path of the light beams L2 in the light mixing channel 2331 is extended, the color uniformity is enhanced and the color separation problem is avoided. Preferably but not exclusively, the light mixing channel 2331 has a helical path and the inner surface 23313 of the light mixing channel 2331 is an irregular surface or a discontinuity surface. Consequently, the number of times the light beams L2 are reflected or diffused by the inner surface 23313 of the light mixing channel 2331 can be increased. In such way, the color uniformity is further enhanced, and the color separation problem is avoided.

From the above descriptions, the light mixing structure 233 comprises plural light mixing channels 2331 and the light beams L2 from the plural light-emitting units 232 are mixed together in the light mixing channels 2331. Moreover, each light mixing channel 2331 has a crooked shape. Consequently, even if the light source module 23 is slim, the light source module 23 can provide uniform light-mixing efficacy. In other words, the thickness of the light source module 23 can be effectively reduced. When the light source module 23 is applied to the electronic device 2, the electronic device 2 can be developed toward small size, slimness and light weightiness.

It is noted that numerous modifications and alterations may be made while retaining the teachings of the invention. For example, in the above embodiment, the electronic device 2 is a sound playback device. Alternatively, the electronic device 2 is a mouse device or a keyboard device, and the light source module 23 is installed in the electronic device 2. In the above embodiment, the electronic device 2 has a cylindrical shape. Alternatively, the electronic device 2 has a polygonal column shape or an irregular column shape, and the profiles of the supporting substrate 231 and the light mixing structure 233 are adjusted according to the shape of the electronic device 2.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A light source module, comprising:
a supporting substrate;
plural light-emitting units electrically connected with the supporting substrate, wherein the plural light-emitting units emit light beams; and
a light mixing structure disposed on the supporting substrate, and comprising plural light mixing channels, wherein the light mixing channels are respectively aligned with the corresponding light-emitting units, at least one of the plural light mixing channels has a crooked shape, and each light mixing channel has a channel inlet and a channel outlet,
wherein each light-emitting unit is located at the channel inlet of the corresponding light mixing channel, wherein after the light beams emitted by each light-emitting unit are introduced into the corresponding light mixing channel through the channel inlet, the light beams are mixed together in the corresponding light mixing channel, and the mixed light beams are outputted from the channel outlet of the corresponding light mixing channel.

2. The light source module according to claim 1, wherein each light-emitting unit comprises a red light emitting diode chip, a green light emitting diode chip and a blue light emitting diode chip, wherein the red light emitting diode chip emits a red light beam, the green light emitting diode chip emits a green light beam, and the blue light emitting diode chip emits a blue light beam.

3. The light source module according to claim 2, wherein the red light emitting diode chip, the green light emitting diode chip and the blue light emitting diode chip are packaged as a polychromatic light emitting diode chip.

4. The light source module according to claim 1, wherein each light-emitting unit comprises at least one micro light emitting diode chip.

5. The light source module according to claim 1, wherein the light mixing channel with the crooked shape has a helical path.

6. The light source module according to claim 1, wherein an inner surface of each light mixing channel has an irregular surface or a discontinuity surface, and the light beams are reflected or diffused by the inner surface of the light mixing channel.

7. The light source module according to claim 1, wherein the supporting substrate is a flexible printed circuit board (FPC), a printed circuit board (PCB) or a resin board (PET).

8. The light source module according to claim 1, wherein the light mixing structure has a ring-shaped profile.

9. The light source module according to claim 1, wherein the light source module is installed in a sound playback device.

10. An electronic device, comprising:
a casing;
a circuit module installed in the casing, wherein the circuit module provides an electronic function; and
a light source module installed on the casing, and comprising:
a supporting substrate;
a light-emitting unit electrically connected with the supporting substrate, wherein the light-emitting unit emits light beams; and
a light mixing structure disposed on the supporting substrate, and comprising a light mixing channel, wherein the light mixing channel is aligned with the light-emitting unit, the light mixing channel has a crooked shape, and the light mixing channel has a channel inlet and a channel outlet,
wherein the light-emitting unit is located at the channel inlet of the light mixing channel, wherein after the light beams emitted by the light-emitting unit are introduced into the light mixing channel through the channel inlet, the light beams are mixed together in the light mixing channel, and the mixed light beams are outputted from the channel outlet of the light mixing channel.

11. The electronic device according to claim 10, wherein the light-emitting unit comprises a red light emitting diode chip, a green light emitting diode chip and a blue light emitting diode chip, wherein the red light emitting diode chip emits a red light beam, the green light emitting diode chip emits a green light beam, and the blue light emitting diode chip emits a blue light beam.

12. The electronic device according to claim 11, wherein the red light emitting diode chip, the green light emitting diode chip and the blue light emitting diode chip are packaged as a polychromatic light emitting diode chip.

13. The electronic device according to claim 10, wherein the light-emitting unit comprises at least one micro light emitting diode chip.

14. The electronic device according to claim 10 wherein the light mixing channel has a helical path.

15. The electronic device according to claim 10, wherein an inner surface of the light mixing channel has an irregular surface or a discontinuity surface, and the light beams are reflected or diffused by the inner surface of the light mixing channel.

16. The electronic device according to claim 10, wherein the supporting substrate is a flexible printed circuit board (FPC), a printed circuit board (PCB) or a resin board (PET).

17. The electronic device according to claim 10, wherein the light mixing structure has a ring-shaped profile.

18. The electronic device according to claim 10, wherein the electronic device is a sound playback device.
